(19) United States
(12) Patent Application Publication
(10) Pub. No.: US 2026/0358311 A1
(43) Pub. Date: Nov. 12, 2026

(54) DIGITALLY CONTROLLED PERISTALTIC PUMP FOR ION CHROMATOGRAPHY

(71) Applicant: DIONEX CORPORATION, Sunnyvale, CA (US)

(72) Inventors: Gary Gleave, Pleasanton, CA (US); Mrinal Sengupta, Union City, CA (US); Paul Stuart, Redwood City, CA (US); Christopher Shevlin, Sheridan, WY (US)

(21) Appl. No.: 19/486,270

(22) PCT Filed: May 21, 2024
(86) PCT No.: PCT/US2024/030362

§ 371 Date: Nov. 20, 2025

Related U.S. Application Data
(60) Provisional application No. 63/468,144, filed on May 22, 2023.

(51) Int. Cl. G01N 30/96; G01N 30/32

(52) U.S. Cl. CPC G01N 30/96; G01N 30/32; G01N 2030/326

(57) ABSTRACT

Systems and methods taught herein include a peristaltic pump placed along a regenerant flow path to supply regenerant fluid to ion exchange devices (such as chemical suppressors) and other devices within a chromatography system. The peristaltic pump provides steady and highly controllable flow rates that improve run-to-run reproducibility within the system and does not require that the regenerant supply be placed under pressure. Some systems and methods taught herein use peristaltic pumps to enable steady delivery of other fluids, such as water, to related systems such as ion exchange devices operating in electrolytic mode.

### CROSS REFERENCE TO RELATED APPLICATIONS

This application claims priority to U.S. Provisional Patent Application No. 63/468,144, filed May 22, 2023, the entire contents of which is incorporated herein by reference.

### BACKGROUND

In Ion Chromatography (IC) applications, the role of an ion exchange device is to enhance the conductivity signal. In general, a suppression reaction utilizes a regenerant source of ions which is supplied either externally or via recycle mode, exchanges with the eluent and sample counterions through ion exchange transport mechanism resulting in a suppressed eluent background with improved analyte response. Suppression can be achieved primarily via two pathways, chemically regenerated ion exchange devices and electrolytically regenerated ion exchange devices. The regenerant source for chemical suppression can use an external regenerant delivery pathway while an electrolytic ion exchange device can be operated with either an external or recycled regenerant delivery pathway.

### SUMMARY

Provided herein is an ion chromatography system including a chromatographic separation device to separate analytes within a sample fluid. The ion chromatography system also includes an ion exchange device to receive sample fluid from the chromatographic separation device. The ion chromatography system also includes a peristaltic pump to supply regenerant fluid to the ion exchange device.

Provided herein is a method of performing ion chromatography. The method includes separating analytes within a fluid sample in a chromatographic separation device. The method also includes suppressing the conductivity of non-analyte electrolytes in the separated fluid sample using an ion exchange device. The method also includes supplying regenerant fluid to the ion exchange device using a peristaltic pump. The method also includes detecting the analytes in the separated fluid sample using a detector.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a chromatography system for ion separation including a regenerant peristaltic pump in accordance with various embodiments taught herein.

FIG. 2 illustrates a perspective view of the peristaltic pump according to various embodiments taught herein in an open condition.

FIG. 3 illustrates the peristaltic pump in the closed condition.

FIG. 4 illustrates an exploded view of the peristaltic pump.

FIG. 5 illustrates a reverse angle view of the peristaltic pump.

FIG. 6 illustrates the chromatography system in cabinet format with the peristaltic pump mounted on a front panel of the chromatography system.

FIG. 7 illustrates a graphical user interface (GUI) for a chromatography system in accordance with various embodiments taught herein.

FIG. 8 includes a plot showing results of a reproducibility experiment performed using the chromatography system according to embodiments described herein.

FIG. 9A illustrates an example chromatography system that includes a carbonate removal device connected via a first regenerant flow path arrangement in accordance with various embodiments taught herein.

FIG. 9B illustrates a chromatography system that includes a carbonate removal device 902 having a second regenerant flow path arrangement according to some embodiments taught herein.

FIG. 10 illustrates a chromatography system that includes post column reagent delivery according to some embodiments taught herein.

### DETAILED DESCRIPTION

The section headings used herein are for organizational purposes only and are not to be construed as limiting the described subject matter in any way.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless described otherwise, all technical and scientific terms used herein have a meaning as is commonly understood by one of ordinary skill in the art to which the various embodiments described herein belongs.

It will be appreciated that there is an implied “about” prior to the temperatures, concentrations, times, pressures, flow rates, cross-sectional areas, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

As used herein, “a” or “an” also may refer to “at least one” or “one or more.” Also, the use of “or” is inclusive, such that the phrase “A or B” is true when “A” is true, “B” is true, or both “A” and “B” are true. Further, unless otherwise required by context, singular terms shall include pluralities and plural terms shall include the singular.

A “system” sets forth a set of components, real or abstract, comprising a whole where each component interacts with or is related to at least one other component within the whole.

As used herein, “eluent” is a liquid that contains an acid, base, salt, or mixture thereof and can be used to elute an analyte through a chromatography column. In addition, an eluent can include a mixture of a liquid and a water miscible organic solvent, where the liquid may include an acid, base, salt, or combination thereof.

In some embodiments taught herein, an electrolytic eluent generator can be provided to generate a generant. As used herein, “generant” refers to a particular species of acid, base, or salt that can be added to the eluent. In an embodiment, the generant may be a base such as cation hydroxide or the generant may be an acid such as carbonic acid, phosphoric acid, acetic acid, methanesulfonic acid, or a combination thereof.

Systems and methods taught herein include a peristaltic pump placed along a regenerant flow path to supply regenerant fluid to ion exchange devices and other devices within a chromatography system. The peristaltic pump provides steady and highly controllable flow rates that improve run-to-run reproducibility within the system and does not require that the regenerant supply be placed under pressure. In displacement chemical regeneration (DCR), the concentration of the regenerant solution is regularly adjusted through dilution. This requirement for regular adjustment provides a possible source of error if the regenerant solution is not at the expected or anticipated concentration during an experimental run. Conventionally, regenerant solution is supplied to the system from bottles that are placed under pressure using a pressurized gas source. The gas source forces the regenerant solution out of the bottle at the appropriate rate and concentration. However, with pressurized feed, the regenerant delivery flow rate is prone to pressure changes downstream and can depend upon the level of regenerant remaining in the container, both of which can cause changes or spikes in flow rate and impact the chromatographic performance. The use of the peristaltic pump to supply regenerant fluid as taught herein can overcome these issues as the flow rate is very stable and is also not susceptible to pressure changes in the flow path or the level of regenerant remaining in the supply container. Thus, the resulting chromatographic performance of systems of the present disclosure is very reproducible.

Additionally, systems and methods taught herein can improve safety by obviating the need for pressurization of regenerant fluid containers. DCR supports low to medium concentrations of eluents (cation and anion) and is mostly recommended for carbonate-based chemistry applications. Due to most eluents and regenerants being caustic or corrosive, conventional systems employing pressurized bottles present a safety hazard as operators can potentially be harmed by forced expulsion of fluid or explosion of containers particularly during the repeated mixing and filing of these pressurized vessels that is part of the DCR process. Systems and methods taught herein can improve safety by using peristaltic pumps to provide steady supply of regenerant from unpressurized regenerant supplies such as vessels or containers.

Some systems and methods taught herein use peristaltic pumps to enable steady delivery of other fluids, such as water, to related systems such as ion exchange devices operating in electrolytic mode. For certain applications, systems and methods taught herein can use peristaltic pumps to supply recycled regenerant to an ion exchange device. Additionally, systems and methods taught herein use peristaltic pumps to steadily deliver gas or fluid to carbonate removal devices that physically or chemically remove dissolved carbon dioxide gas from fluid (such as eluent) along flow paths.

Various methods are used for supplying a regenerant fluid flow with regular and stable flow typically provided through an additional dedicated peristaltic pump. Whereas many regenerant pumps are external to the IC instrument, this disclosure provides for an internally or externally mounted peristaltic pumping solution including peristaltic pumps allowing more immediate and synchronized delivery approach for chemical or electrolytic suppression. The technical field of the regenerant peristaltic pump is its use with analytical IC instruments in sample preparation, post sample handling or during the operational process of analysis with applications. Some examples of devices taught herein can be used in any liquid chromatography application where there is a desire for providing a low-pressure, stable flow of liquid.

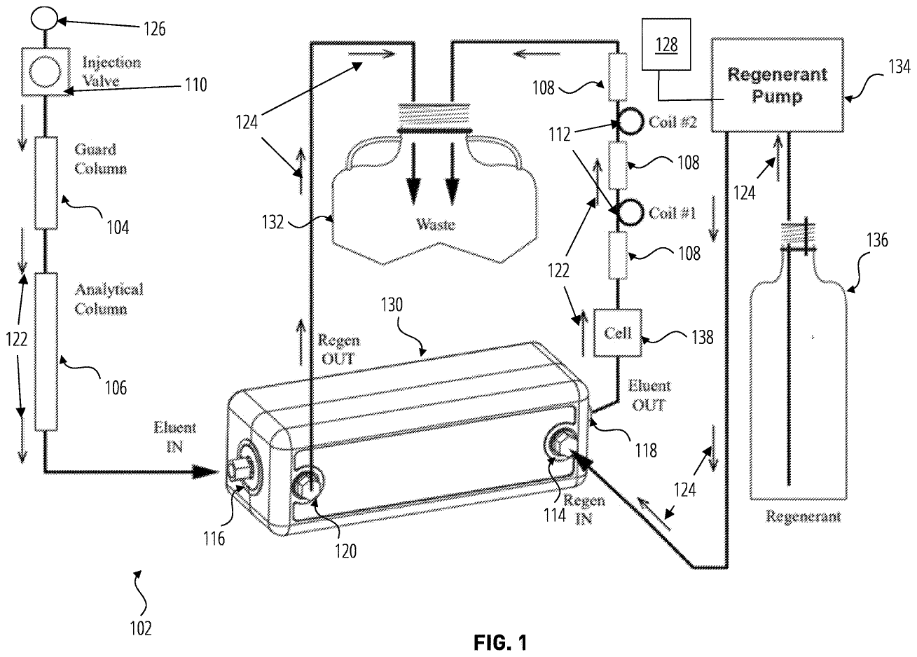

FIG. 1 illustrates a chromatography system 102 for ion separation including a regenerant peristaltic pump 134 in accordance with various embodiments taught herein. The chromatography system 102 includes an injection valve 110 that receives eluent or sample fluid from a high pressure input 126, a guard column 104, a chromatographic separation device 106, an ion exchange device 130, a detector 138, flow units 108, backpressure coils 112, and a waste output 132 along a sample flow path 122. The chromatography system 102 also includes a peristaltic pump 134 that supplies regenerant fluid from a regenerant supply 136 along a regenerant flow path 124 to the ion exchange device 130 and the waste output 132. The chromatography system 102 can also include a microprocessor 128. The use of a peristaltic pump 134 is to provide regenerant to the ion exchange device 130, which enables more immediate and synchronized delivery approach for chemical suppression than with conventional chromatography systems.

The sample fluid (which can include sample such as analytes and eluent) is supplied to the chromatography system 102 at the high pressure input 126 along the sample flow path 122. The sample fluid passes through the injection valve 110, which can be enabled to allow sample fluid to pass or disabled to prevent sample fluid from flowing along the sample flow path 122. Fluid can enter the high pressure input 126 from a high pressure pump and can include eluent produced by, for example, an eluent generator.

The sample fluid flows through the guard column 104 along the sample flow path 122. The guard column 104 is a short column or cartridge that is installed before the chromatographic separation device 106 such as an analytical column or capillary column. The guard column 104 can act as a filter to prevent particulates from entering the chromatographic separation device 106 and can trap any chemical contaminants with a high affinity for the stationary phase. As a result, the guard column 104 can help to ensure the integrity of high or ultrahigh pressure liquid chromatography ((U)HPLC) results and increase data reproducibility by removing chemical impurities that could prevent the chromatographic separation device 106 from effectively retaining target analytes from the sample. By retaining physical contaminants, the guard column 104 can increase the lifetime of the chromatographic separation device 106 by reducing the chance of column blockage. In some embodiments, the guard column 104 is optional and may be omitted from the sample flow path 122.

The sample fluid flows through the chromatographic separation device 106 (also sometimes referred to as an analytical column). The chromatographic separation device 106 can separate various matrix components present in the liquid sample from the analyte(s) of interest. Typically, chromatographic separation device 106 may be in the form of a hollow cylinder that contains a packed stationary phase. As the liquid sample flows through chromatographic separation device 106, the matrix components and target analytes can have a range of retention times for eluting off of chromatographic separation device 106. Depending on the characteristics of the target analytes and matrix components, they can have different affinities to the stationary phase in chromatographic separation device 106. An output of chromatographic separation device 106 can be fluidically connected to the ion exchange device 130.

The ion exchange device 130 can be used to reduce eluent conductivity background and enhance analyte response through efficient exchange of eluent counterions for regenerant ions. In some embodiments, the ion exchange device 130 can be a chemically regenerated suppressor. The ion exchange device 130 receives sample fluid at a sample inlet 116 and outputs sample fluid at a sample outlet 118. The ion exchange device 130 also receives regenerant at a regenerant inlet 114 and outputs regenerant at a regenerant outlet 120. In Ion Chromatography (IC) applications, the ion exchange device 130 enhances the conductivity signal of the analyte. In general, a suppression reaction utilizes a regenerant source of ions which is supplied either externally or via recycle mode, exchanges with the eluent and sample counterions through ion exchange transport mechanism resulting in a suppressed eluent background with improved analyte response. In various embodiments, the ion exchange device 130 can operate continuously if supplied with an external regenerant liquid source.

In some embodiments, the ion exchange device 130 suppresses the conductivity of the electrolyte of the eluent from the chromatographic separation device 106 but not the conductivity of the separated ions (i.e., sample). The conductivity of the separated ions is usually enhanced in the suppression process. For instance, an exemplary anion Cl⁻ can be enhanced by converting it to the acid form HCl. After passing through the ion exchange device 130, the eluent is neutralized to produce its weakly ionized form. For instance, the exemplary eluent OH⁻ can be neutralized by reacting it with a hydronium ion to form water. Typically, the ion exchange device 130 includes a primary channel connecting the sample inlet 116 and sample outlet 118 through which an ionic species flows and a regenerant channel connecting the regenerant inlet 114 to the regenerant outlet 120 through which a regenerant flows. One will appreciate that the ion exchange device can be used for IC suppression as well as sample pre-treatment and other uses, and as such, the primary channel may direct an eluent with an ionic species flow, or alternatively, may simply direct a liquid including an ionic species. An example of a suppressor that is suitable for use as the ion exchange device 130 in chromatography systems 102 of the present disclosure is described in U.S. patent application Ser. No. 18/055,064, filed Nov. 14, 2022, the entire contents of this application being incorporated herein by reference.

One type of ion exchange device 130 is an electrolytic suppressor (sometimes referred to as a salt converter) that includes an anode chamber, a cathode chamber, and an eluent suppression bed chamber separated by ion exchange membranes. The anode chamber and/or cathode chamber can produce regenerate ions or transport supplied regenerant ions. The eluent suppression bed chamber can include a flow path for the eluent separated from the regenerant by an ion exchange barrier, and eluent counterions can be exchanged with regenerant ions across the ion exchange barrier. The electrolytic suppressor is recharged by providing water to the regenerant inlet. As such, electrolytic suppressors are a class of ion exchange device 130 that benefits from the use of the peristaltic pump 134 as the peristaltic pump 134 provides a regular, stable water source.

The sample outlet 118 can be fluidically connected to the detector 138 to measure the presence of the separated chemical constituents of the liquid sample. Any ion exchange device 130 (e.g., suppressor) known to one of ordinary skill in the art is suited for the present application with multiple channels as configured.

In some embodiments, the chromatography system 102 can include a supply of check standards that can reduce errors in measurements from the chromatography system 102 and/or calibrate measurements in the chromatography system 102. The supply of check standards can be included in the sample flow path 122, e.g., between the guard column 104 and the chromatographic separation device 106. Some chromatography systems 102 according to the present disclosure can include a recycling system for check standards. Check standard supplies and recycling systems that are compatible with chromatography systems 102 of the present disclosure are described in U.S. Patent Application Publication 2023/0075933, published Mar. 9, 2023, the entire contents of this application publication being incorporated herein by reference.

The detector 138 can include an ultraviolet-visible spectrometer, a fluorescence spectrometer, a refractive index detector, a radio flow detector, a chiral detector, an electrochemical detector, a conductivity detector, or any combination thereof. The detector 138 is preferably a non-destructive detector that preserves substantially the eluent stream received from the sample outlet 118 of the ion exchange device 130.

Sample fluid can flow from the detector 138 to one or more flow units 108. The flow units 108 can be separated by backpressure coils 112. In some embodiments, after flowing through the flow units 108 and backpressure coils 112, the sample fluid is delivered to a waste output 132. For example, the waste output can be a waste container or drain (including neutralizing agents to control the acidity/alkalinity of the fluid before disposal).

The ion exchange device 130 receives regenerant delivered by the peristaltic pump 134 from the peristaltic pump 134 along regenerant flow path 124. After used regenerant leaves the regenerant outlet 120 of the ion exchange device 130, the used regenerant can proceed to the waste output 132 such as a drain or waste container.

The peristaltic pump 134 provides a stable supply of regenerant at low pressure to the ion exchange device 130. In some embodiments, the peristaltic pump 134 is quieter (e.g., provides less acoustic vibration) than other fluid delivery devices, which enables lower levels of fluidic disturbance. The peristaltic pump 134 can dispense pulse-free or pulse-dampened fluid to the ion exchange device 130 (e.g., electrolytically or chemically regenerated suppressor) from the regenerant supply 136 such as an external regenerant reservoir or bottle. Because the peristaltic pump 134 draws fluid from the regenerant supply 136 at a constant, controllable rate, fluid in the regenerant supply 136 can be placed at atmospheric pressure. By avoiding pressurizing the regenerant fluid, which can be caustic or corrosive, use of the peristaltic pump 134 improves user safety by avoiding the possibility of user exposure to chemicals that can arise in pressurized environments (i.e., unexpected expulsion or explosion of liquids under pressure). In some embodiments, the peristaltic pump 134 provides regenerant at low pressures. In some embodiments, the peristaltic pump 134 can deliver fluid at fluid flow rates in a range from 0.1 to 10 mL/min.

In some embodiments, the peristaltic pump 134 is connected to the microprocessor 128 to enable direct control of the operation of the peristaltic pump 134 by the microprocessor 128. For example, the microprocessor 128 can operate the peristaltic pump 134 as a digitally interfaced variable flow rate controller with a wide linear dynamic flow range of delivery using a single set of pump tubing on the regenerant flow path 124 having a constant inner diameter. In conventional systems, changing the flow rate of regenerant dynamically was difficult as the tubing along the regenerant flow path 124 would have to be removed and replaced with tubing having a larger or smaller inner diameter. In embodiments of the present disclosure, the microprocessor 128 can control the fluid delivery rate of the peristaltic pump 134 by controlling the rate of speed of the peristaltic pump 134. In some embodiments, the microprocessor 128 can control the flow rate of the regenerant at one static operating value.

In some embodiments, the microprocessor 128 can automatically adjust the flow rate of the regenerant from the peristaltic pump 134 to optimize chemistry results based on smart real-time analytical chemistry feedback data. For example, in the case where the ion exchange device 130 is a chemical suppressor, suppression of eluent conductivity can be performed dynamically by changing the concentration, flow rate, or both concentration and flow rate of the regenerant fluid. The microprocessor 128 can receive signals from the detector 138 or flow units 108 that are indicative of the eluent conductivity and, thus, the results of the real-time analytical chemistry. The microprocessor 128 can then control the peristaltic pump 134 to adjust the flow rate of regenerant fluid to increase or decrease the conductivity until the measured conductivity at the detector 138 matches the desired conductivity. The microprocessor 128 can also address eluent gradient conditions according to certain methods of use of the instrument (e.g., operating methods saved in a memory associated with the microprocessor 128). In some experiments, eluent concentrations may be changed from low to high to low (for example) by the user during a single run. The microprocessor 128 can automatically adjust the flow rate of the peristaltic pump 134 based upon measured or planned eluent concentration changes to provide optimized suppression.

In some embodiments, the peristaltic pump 134 provides regenerant fluid to the ion exchange device 130 during active operation of the ion exchange device 130 to exchange ions along the sample flow path 122. In some conventional devices, the ion exchange device 130 is regenerated off-line while being disconnected from active usage in chromatographic operations. The chromatography system 102 taught herein can regenerate the ion exchange device 130 during active chromatographic operations without removal of the ion exchange device 130 from the sample flow path 122.

In some embodiments, the sample flow path 122 or the regenerant flow path 124 can be formed of a connected series of flow elements including fluidic tubing (e.g., polymer, metal, ceramic, or glass tubing). The fluidic tubing can pass through the body of some components such as the ion exchange device 130. Portions of the flow path can include flexible tubing or tubing with chemical-resistant properties. In some embodiments, the sample flow path or the regenerant flow path can include a portion formed of polyvinyl chloride such as Tygon™ tubing. In some embodiments, an inner diameter of the regenerant flow path can be constant along the entire length of the flow path. In some embodiments, the inner diameter of the portions of the flow path that are external to instruments can be constant and/or the inner diameter can be chosen independently from the desired flow rate. In some embodiments, the inner diameter of flexible tubing along the regenerant flow path is selected to provide ripple-free performance and to support a wide linear range of flow rates. In some conventional instruments, different flexible tubing can be installed into the flow path to select the desired flow rate wherein smaller inner diameter tubing reduces flow rate. As taught herein, a single set of flexible tubing can be used while adjustments are made to the peristaltic pump to change flow rates to provide ripple-free performance.

The backpressure coils 112 can provide a low pressure restrictive outlet path along the sample flow path 122 after the ion exchange device 130 or the detector 138. The backpressure coils 112 can serve to keep a more stable flow through the prior devices and can, in some cases, reduce the size of gas bubbles in route within the fluid stream. The flow units 108 can include additional detectors (i.e., in addition to the detector 138 and, in some cases, complementary to the detector 138) or couplers connecting the backpressure coils to one another, to the detector 138, and to the waste output 132.

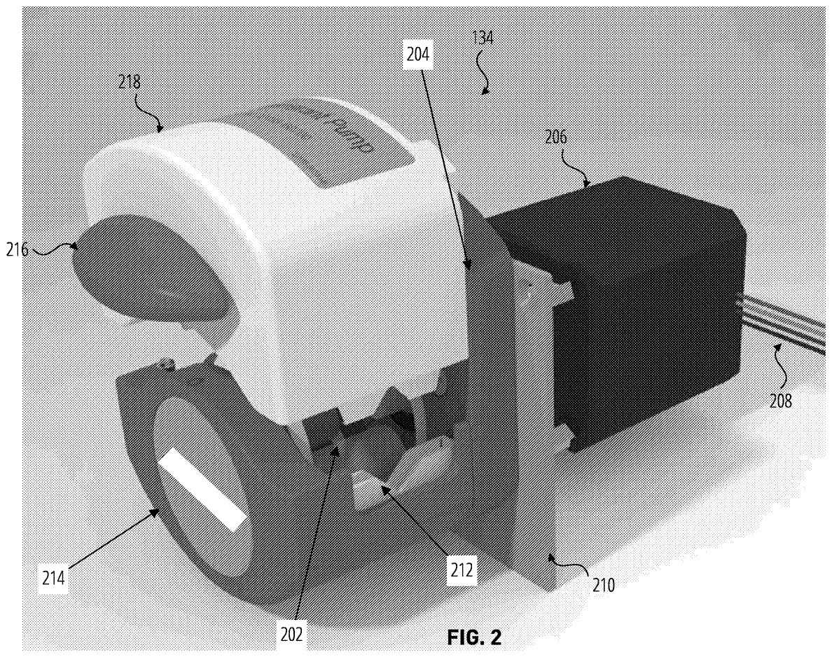

FIG. 2 illustrates a perspective view of the peristaltic pump 134 according to various embodiments taught herein in an open condition wherein fluidic tubing (e.g., a portion of the regenerant flow path 124) can be inserted, removed, or replaced. The peristaltic pump 134 includes a peristaltic pump 134, a mounting plate 210, and a motor casing 206. The peristaltic pump 134 can include an upper portion 218 and a lower portion 214. Fluid tubing passes through a guide 212 that lies between the upper portion 218 and the lower portion 214. A peristaltic mechanism 202 within the peristaltic pump 134 is engaged with a motor in the motor casing 206. As the motor drives the peristaltic mechanism 202 (e.g., a series of wheels or rollers orbiting a center point), the peristaltic mechanism 202 presses against fluidic tubing to cause fluid to flow within the tubing. Notably, fluid tubing can be engaged with the peristaltic mechanism 202 of the peristaltic pump 134 without needing to disconnect the ends of the fluidic tubing (i.e., tubing can be installed or removed from the pump without disrupting the regenerant flow path 124).

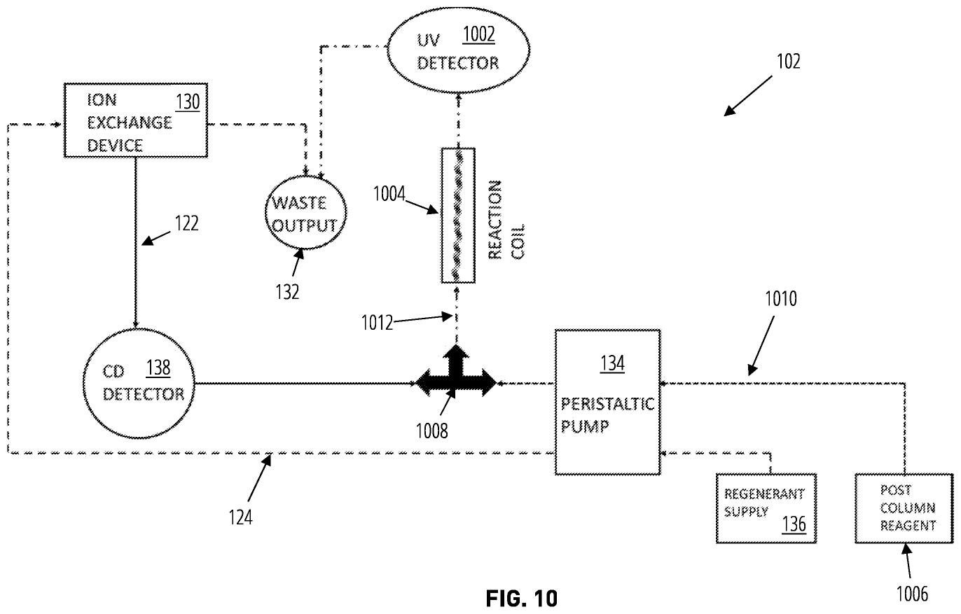

The peristaltic mechanism 202 can include a number of rollers appropriate to particular application needs. In various configurations, the peristaltic mechanism 202 can include 3, 6, 8, or 12 rollers. In applications with dual head configurations (as described with respect to FIG. 10 below), each pump head can employ the same or different numbers of rollers. The use of additional rollers can reduce noise in some examples. Due to the high sensitivity of the detector 138, some applications that employ very low flow rates (e.g., less than about 1.0 mL/min or less than about 0.5 mL/min) experience pressure ripples due to peristaltic pump pulsations. These ripples can create high levels of noise (e.g., suppressed conductivity baseline noise) and reduce signal-to-noise performance. In one example, the electrical conductance noise and signal-to-noise ratio were compared for a pump head 204 employing three rollers vs a pump head 204 employing six rollers. The results are shown in the table below. The six-roller configuration reduced the level of electrical conductance noise and increased the signal-to-noise ratio, particularly for low flow rates.

| Flow rate | 3-roller noise | 3-roller S/N | 6-roller noise | 6-roller S/N |
|---|---|---|---|---|
| (mL/min) | (nS/cm) | ratio | (nS/cm) | ratio |
| 0.2 | 1.106 | 11.6 | 0.306 | 46.6 |
| 0.3 | 0.612 | 22.6 | 0.266 | 51.1 |
| 0.5 | 0.306 | 54.5 | 0.217 | 54.3 |
| 1.0 | 0.190 | 64.9 | 0.169 | 64.3 |

In some embodiments, the upper portion 218 can include a handle 216 to facilitate separation of the upper portion 218 and the lower portion 214. For example, the handle 216 can facilitate lifting of the mobile upper portion 218 (e.g., on rails or hinges) relative to the stationary lower portion 214. The person of ordinary skill in the art appreciates that other embodiments can include the handle 216 attached to the lower portion 214 rather than the upper portion 218 such that the lower portion 214 moves relative to the upper portion 218. In other embodiments, handles 216 can be affixed to both portions and/or the portions can move relative to one another.

Electrical connections 208 extend from the motor casing 206 and connect the peristaltic pump 134 to a power supply, the microprocessor 128, or both. The motor casing 206 includes the motor itself (e.g., brushless motor) that connects to a peristaltic mechanism in the peristaltic pump 134 that applies pressure to the fluid tubing to cause fluid to flow.

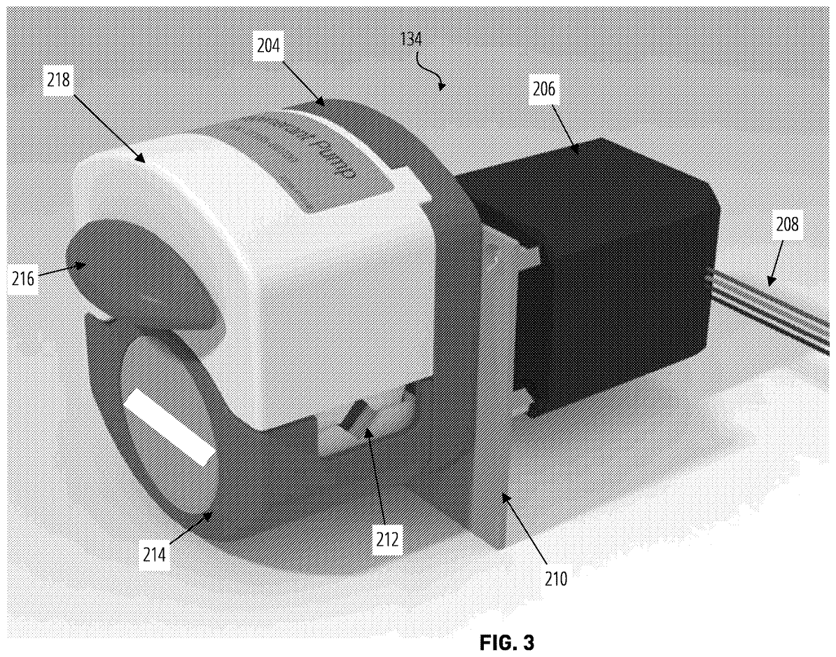

While FIG. 2 illustrated the peristaltic pump 134 in the open condition where the fluidic tubing may be inserted, removed, or replaced, FIG. 3 illustrates the same peristaltic pump 134 in a closed, clamped condition where the peristaltic mechanism can be engaged with fluid tubing.

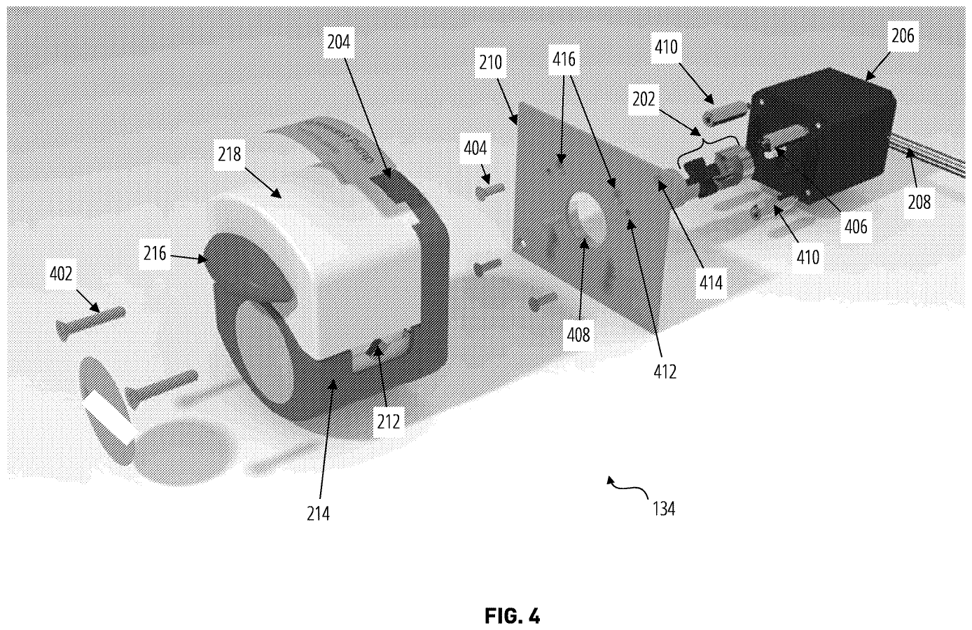

FIG. 4 illustrates an exploded view of the peristaltic pump 134. Fasteners 402 pass through the pump head 204 and attach to respective mount holes 412 in the mounting plate 210. For example, the fasteners 402 can include screws or bolts that couple to threaded mount holes 412 or pass through the mount holes 412 to be secured by a nut on a backside of the mounting plate 210.

A motor 406 extends from the motor casing 206 and engages with the peristaltic mechanism 202. In some embodiments, the peristaltic mechanism 202 can include one or more impellers or wheels that apply pressure to flexible fluidic tubing while translating or rotating to cause fluid to be pushed through the tubing. Upon assembly of the peristaltic pump 134, the peristaltic mechanism 202 can extend through a through hole 408 in the mounting plate 210 and pass into the pump head 204. The motor casing 206 can be secured to the mounting plate 210 through one or more spacers 410 in some embodiments. The spacers 410 can provide an appropriate stand-off distance (depending on size of the motor 406 and/or peristaltic mechanism 202) to ensure that the peristaltic mechanism 202 is seated properly within the pump head 204. Fasteners 404 can pass through spacer holes 416 in the mounting plate 210 with each fastener 402 secured to an end of a respective spacer 410.

In some embodiments, the mounting plate 210 can be secured to a cabinet or case of the chromatography system 102 using mount holes 414. In some embodiments, the pump head 204 is external to the cabinet or case and is user-accessible during normal operation while the motor casing 206 is hidden within the cabinet or case and is not user-accessible during normal operation.

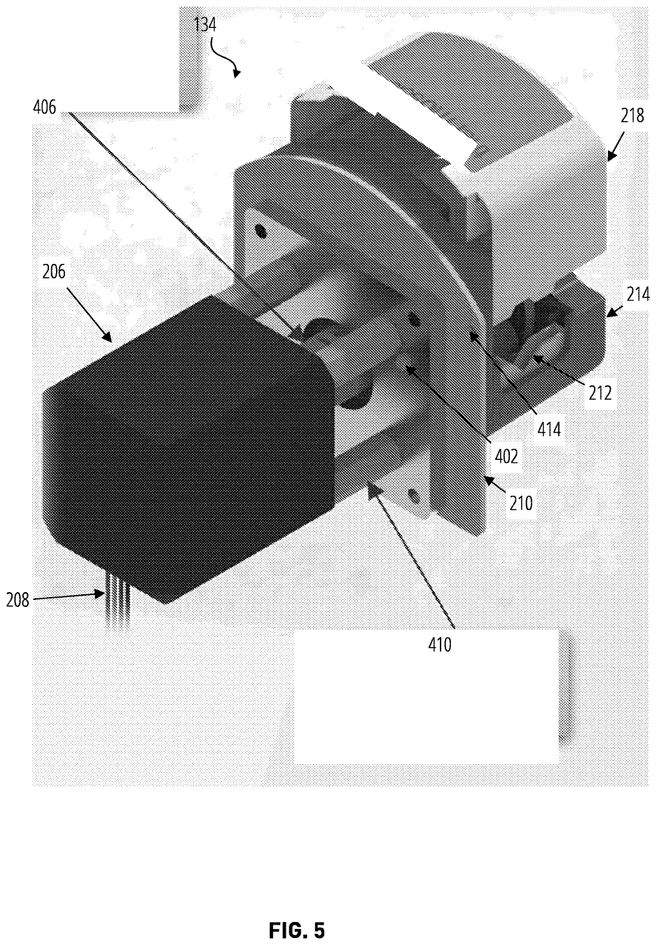

FIG. 5 illustrates a reverse angle view of the peristaltic pump 134. The spacers 410 create a stand-off distance between the motor casing 206 and the mounting plate 210.

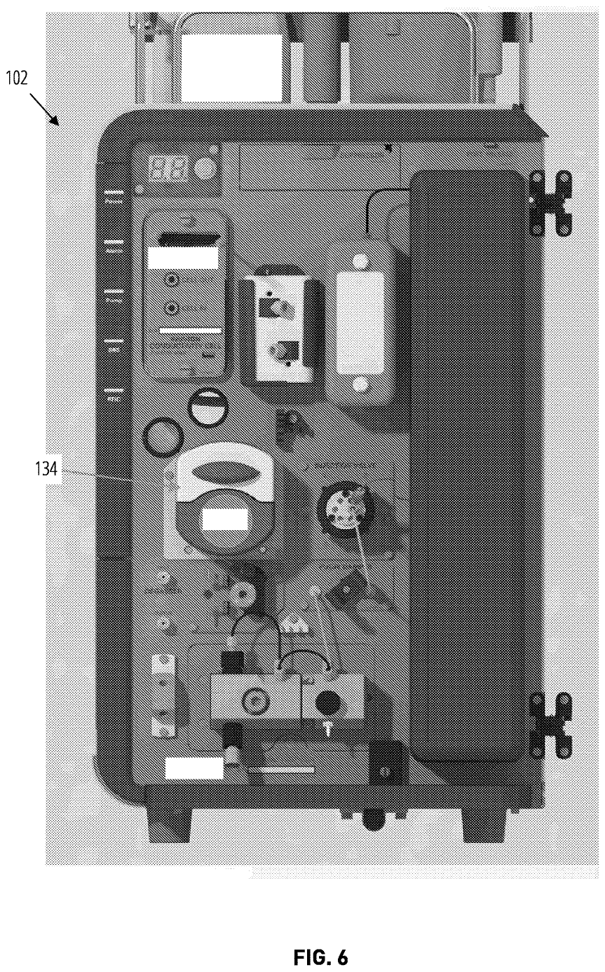

FIG. 6 illustrates the chromatography system 102 in cabinet format with the peristaltic pump 134 mounted on a front panel of the chromatography system 102. The peristaltic pump 134 can be mounted internally or externally (i.e., stand alone) with respect to the chromatography system 102 in various embodiments.

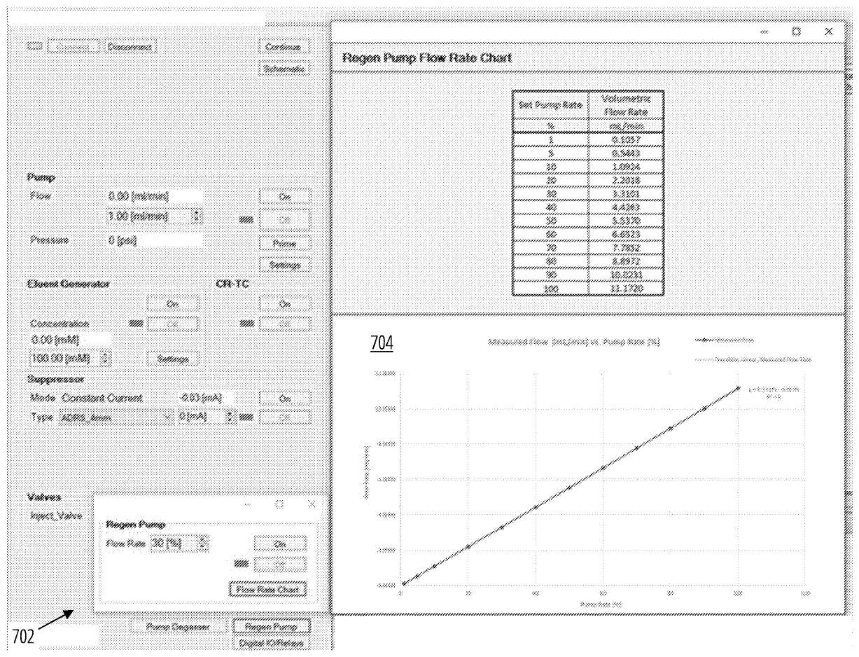

FIG. 7 illustrates a graphical user interface (GUI 702) for a chromatography system 102 in accordance with various embodiments taught herein. The GUI 702 can include various windows having graphical control and readout elements to enable control and display of system parameters or variables. In one embodiment, a results window 704 of the GUI 702 can include a flow rate chart or table that provides volumetric flow rates as a function of pump rate. The pump rate can vary within a range of 0 to 100%. Use of a peristaltic pump 134 in accordance with various embodiments taught herein can result in a linear relationship between pump rate and flow rate. This linear relationship increase predictability during incremental ramping. The incremental percentage settings of the pump motor can be programmed to linearly align with the amount of delivered liquid flow and is not dependent upon uniformity of voltage levels delivered to the pump motor. This represents an improvement over conventional pumps where the levels of voltage delivery to the motor are not directly aligned to the desired consistency of the flow. In some examples, the relationship between pump rate (e.g., as controlled by voltage applied to the pump) and flow rate can change over time due to softening or other structural changes to the tubing after extended usage or due to environmental factors. To account for these changes, the GUI 702 can provide the user with a control to modify the slope of the curve defining the relationship between pump rate and flow rate to achieve the target flow rate. In some examples, the GUI 702 can provide the user with a control to define a non-linear relationship between the pump rate and the flow rate. In some examples, the GUI 702 can provide user control of the flow rate by direct specification of the flow rate, e.g., in mL/minute. For example, the user can set the flow rate within a range of 0 mL/min to 10 mL/min.

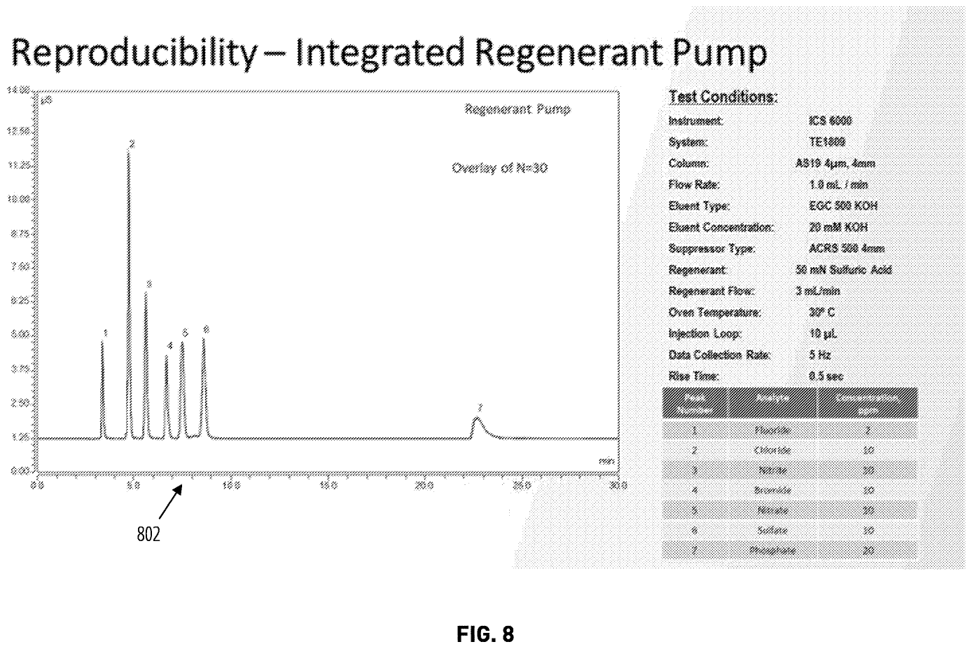

FIG. 8 includes a plot 802 showing results of a reproducibility experiment performed using the chromatography system 102 according to embodiments described herein. In the experiment, seven analytes (fluoride, chloride, nitrite, bromide, nitrate, sulfate, and phosphate) are eluted through the chromatography system 102. Elution intensity peaks are measured as a function of time. The experiment is repeated 30 times and the traces are overlaid to form the plot 802. As illustrated in the plot 802, the overlap between chromatograms measured on different runs is substantial such that scarcely any deviation between runs is observed. Because the peristaltic pump 134 provides repeatable and controllable pump speeds, run-to-run variability is strongly reduced leading to a reliable quantitation of data.

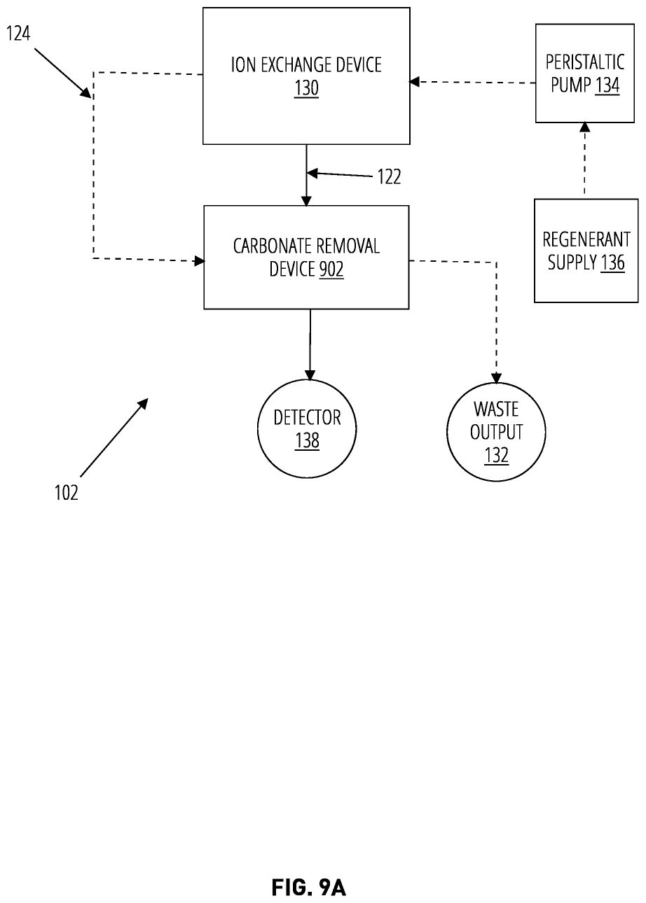

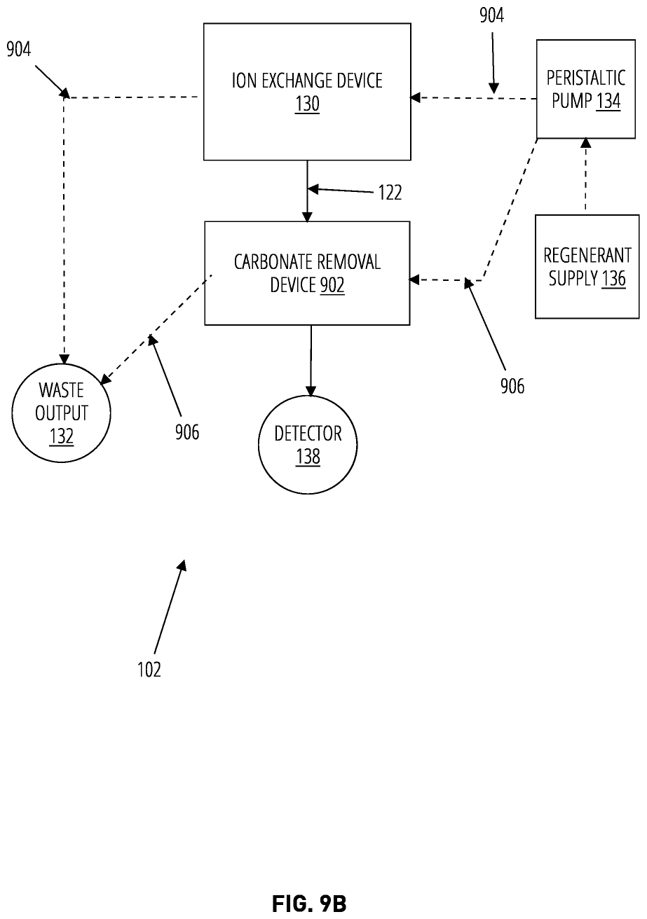

FIG. 9A illustrates an example chromatography system 102 that includes a carbonate removal device 902. In FIG. 9A, the sample flow path 122 is illustrated by solid lines while the regenerant flow path 124 is illustrated by dashed lines. The carbonate removal device 902 receives sample fluid from the ion exchange device 130 (such as a suppressor) and sends sample fluid to the detector 138. The peristaltic pump 134 supplies regenerant fluid from the regenerant supply 136 to the ion exchange device 130 along the regenerant flow path 124. The regenerant fluid then flows out of the ion exchange device 130 and into the carbonate removal device 902 under pressure from the peristaltic pump. Finally, the regenerant fluid can exit the carbonate removal device 902 and flow to the waste output 132.

In some embodiments, the peristaltic pump 134 can supply a basic solution to the carbonate removal device 902 (CRD) or pull a vacuum across a gas permeable membrane within the carbonate removal device 902. The gas permeable membrane is designed to remove carbon dioxide gas from the sample fluid stream (analytes and eluent). The carbonate removal device 902 can help to provide a low background conductivity and improved baseline noise resulting in maximizing signal-to-noise ratios for the target analytes. The action of the peristaltic pump 134 can pull the vacuum across the gas permeable membrane to physically draw dissolved carbon dioxide gas from the eluent in some embodiments. In other embodiments, the action of the peristaltic pump 134 can circulate a basic regenerant solution through a compartment on the opposite side of the gas permeable membrane from the eluent to chemically draw dissolved carbon dioxide gas from the eluent and convert to aqueous sodium carbonate.

FIG. 9B illustrates a chromatography system 102 wherein the peristaltic pump 134 connects to the ion exchange device 130 along a first flow path 904 and connects to the carbonate removal device 902 along a second flow path 906. In some embodiments, the peristaltic pump 134 can have a dual channel setup that enables two sets of fluidic tubing to be operated by a single peristaltic mechanism 202. As such, first flow path 904 and second flow path 906 can be fluidically isolated from one another while each simultaneously supplies fluid to components in the chromatography system 102. In various embodiments, the first flow path 904 exiting the ion exchange device 130 and the second flow path 906 exiting the carbonate removal device 902 can collect at the same or different waste outputs 132.

FIG. 10 illustrates a chromatography system 102 that includes post column reagent delivery according to some embodiments taught herein. In this embodiment, the regenerant flow path 124 is similar to that described above with respect to FIG. 1. However, the peristaltic pump 134 is a dual-head or dual channel pump that operates the regenerant flow path 124 as well as a reagent flow path 1010. The supply of post-column reagents can enable additional forms of sensing or detection such as detection based upon ultraviolet light illumination. The peristaltic pump 134 draws fluid with a post-column reagent from a reagent supply 1006 along the reagent flow path 1010. The reagent flow path 1010 and the sample flow path 122 merge together at a fluid junction 1008 to form a post-column flow path 1012. The post-column flow path 1012 flows through a reaction coil 1004. The reaction coil 1004 promotes reaction between any remaining analytes that were not able to be detected by the detector 138 and post-column reagent. For example, the post-column reagents and analytes can chemically bind together. The post-column flow path 1012 then flows past an ultraviolet light detector 1002 that illuminates the post-column flow path 1012 with ultraviolet light and measures the response using a light detector. The light response can be proportional to the quantity of analyte in the post-column flow path 1012. The peristaltic pump 134 can supply a stable, ripple-free flow of post-column reagent while also providing steady flow of regenerant to the ion exchange device and/or to carbonate removal devices (not shown).

It is to be appreciated that certain features of the disclosure which are, for clarity, described herein in the context of separate embodiments, may also be provided in combination in a single embodiment. That is, unless obviously incompatible or excluded, each individual embodiment is deemed to be combinable with any other embodiment s) and such a combination is considered to be another embodiment. Conversely, various features of the disclosure that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

When a list is presented, unless stated otherwise, it is to be understood that each individual element of that list and every combination of that list is to be interpreted as a separate embodiment. For example, a list of embodiments presented as “A, B, or C” is to be interpreted as including the embodiments, “A,” “B,” “C,” “A or B,” “A or C,” “B or C,” or “A. B, or C.”

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art. Furthermore, features from separate lists can be combined; and features from the examples can be generalized to the whole disclosure.

1. An ion chromatography system, comprising:
a chromatographic separation device to separate analytes within a sample fluid;
an ion exchange device to receive sample fluid from the chromatographic separation device; and
a peristaltic pump to supply regenerant fluid to the ion exchange device.

2. The ion chromatography system of claim 1, further comprising:
an unpressurized regenerant supply; and
fluidic tubing to carry the regenerant fluid from the regenerant supply to the ion exchange device, wherein the peristaltic pump can engage and disengage with the fluidic tubing while the fluidic tubing is connected to the regenerant supply and the ion exchange device.

3. (canceled)

4. The ion chromatography system of claim 1, wherein the peristaltic pump supplies the regenerant fluid at a flow rate in a range from 0.1 to 10 mL/min.

5. The ion chromatography system of claim 1, further comprising a microprocessor in communication with the peristaltic pump, the microcontroller configured to execute instructions to:
control a flow rate of the regenerant fluid by controlling a speed of the peristaltic pump.

6. (canceled)

7. The ion chromatography system of claim 5, wherein the microprocessor is further configured to execute instructions to:
determine a conductivity of the regenerant fluid based on signals received from a detector or a flow unit;
dynamically control the flow rate to increase or decrease the conductivity; and
iteratively repeat the steps of determining the conductivity and dynamically controlling the flow rate until the conductivity matches a desired conductivity.

8. The ion chromatography system of claim 5, wherein the microprocessor controls the flow rate of the regenerant fluid based on measured or planned eluent concentration changes.

9. The ion chromatography system of claim 5, wherein the microprocessor is configured to execute further instructions to:
display a flow rate chart showing volumetric flow rates as a function of pump rate using a graphical user interface (GUI).

10. The ion chromatography system of claim 1, further comprising a carbonate removal device that receives regenerant fluid from the ion exchange device under pressure from the peristaltic pump.

11. (canceled)

12. The ion chromatography system of claim 10, wherein the peristaltic pump applies a vacuum to a gas permeable membrane of the carbonate removal device.

13. The ion chromatography system of claim 1, wherein the peristaltic pump is a dual-head or dual-channel peristaltic pump.

14. The ion chromatography system of claim 13, wherein the peristaltic pump delivers regenerant fluid along a first flow path, and
wherein the peristaltic pump delivers post-column reagent from a reagent supply along a second flow path to a fluid junction downstream of the ion exchange device.

15. A method of performing ion chromatography, comprising:
separating analytes within a fluid sample in a chromatographic separation device;
suppressing the conductivity of non-analyte electrolytes in the separated fluid sample using an ion exchange device;
supplying regenerant fluid to the ion exchange device using a peristaltic pump; and
detecting the analytes in the separated fluid sample using a detector.

16. The method of claim 15, wherein supplying regenerant fluid includes obtaining regenerant fluid from a regenerant supply held at atmospheric pressure by carrying regenerant fluid within fluidic tubing from the regenerant supply to the ion exchange device; the method further comprising
disengaging the peristaltic pump from the flexible tubing while the flexible tubing remains connected to the regenerant supply and the ion exchange device.

17. (canceled)

18. (canceled)

19. The method of claim 15, further comprising controlling a flow rate of the regenerant fluid using a microprocessor in communication with the peristaltic pump to control a speed of the peristaltic pump.

20. (canceled)

21. The method of claim 19, further comprising:
determining a conductivity of the regenerant fluid based on signals received from the detector or a flow unit;
dynamically controlling the flow rate to increase or decrease the conductivity; and
iteratively repeating the steps of determining the conductivity and dynamically controlling the flow rate until the conductivity matches a desired conductivity.

22. The method of claim 19, wherein controlling the flow rate includes changing the flow rate in response to measured or planned eluent concentration changes.

23. The method of claim 19, further comprising:
displaying a flow rate chart showing volumetric flow rates as a function of pump rate using a graphical user interface (GUI).

24. The method of claim 15, further comprising removing carbon dioxide gas from the separated fluid sample using a carbonate removal device; and
supplying regenerant fluid to the carbonate removal device from the ion exchange device under pressure from the peristaltic pump.

25. (canceled)

26. The method of claim 24, further comprising applying a vacuum to a gas permeable membrane of the carbonate removal device using the peristaltic pump.

27. The method of claim 15, wherein the peristaltic pump is a dual-head or dual-channel peristaltic pump,
wherein supplying regenerant fluid occurs along a first flow path, the method further comprising:
delivering post-column reagent from a reagent supply along a second flow path to a fluid junction downstream of the ion exchange device.
